(19) United States
(12) Patent Application Publication
(10) Pub. No.: US 2026/0084812 A1
(43) Pub. Date: Mar. 26, 2026

(54) SYSTEM AND METHOD FOR UNMANNED AERIAL VEHICLE-ENABLED DELIVERY OF CARGO WITHOUT HUMAN INTERVENTION

(71) Applicant: AutoBotx, LLC

(72) Inventors: David Kilzer, Tempe, AZ (US); Craig Foster, Scottsdale, AZ (US)

(21) Appl. No.: 19/170,396

(22) Filed: Apr. 4, 2025

Related U.S. Application Data
(63) Continuation of application No. 17/588,237, filed on Jan. 29, 2022, now abandoned.

(51) Int. Cl. B64D 1/22; B64D 1/10; B64D 1/12; B64D 9/00; B64F 1/32; B64U 10/16; B64U 50/19; B64U 101/66; G05D 1/00

(52) U.S. Cl. CPC B64D 1/22; B64D 1/10; B64D 1/12; B64D 9/003; B64F 1/322; B64D 2201/00; B64U 10/16; B64U 50/19; B64U 2101/66; B64U 2201/10

(57) ABSTRACT

An unmanned cargo loading and transport system adapted for operation with an unmanned aerial vehicle (UAV) comprising a payload pad comprising a plurality of support members movable from an extended mode to a retracted mode when exposed to a lateral force applied to the support members and a payload container adapted to attach to a UAV and pick up cargo from the payload pad by transferring the weight of the cargo from the payload pad to the payload container. The lower portion of the payload container comprises two generally opposed cargo doors movably mounted at opposed sides and movable inwardly to a closed position and outwardly to an open position to receive cargo when the payload container is positioned at the payload pad. The system further comprises a motive power mechanism coupled to the cargo doors for selectively moving the doors between their open and their closed positions.

### BACKGROUND

### 1. Field of the Invention

The present invention generally relates to the field of cargo delivery services by unmanned aerial vehicles (UAVs) and more specifically relates to the payload container that is attached to and employed by UAVs to load, transport, and unload cargo and the complementary apparatus to hold the cargo and interact with the payload container during the cargo loading and unloading process.

### 2. Description of Related Art

UAV delivery of cargo has been under consideration and development for several years. However, while UAV delivery of various items (munitions, supplies, and others) by military organizations is well advanced, and there are some medical-related delivery services by UAVs (for example, transport of medical samples between hospitals and laboratories, delivery of critical medical supplies to remote locations and others), the use of UAVs for delivery to the general public remains rare and employed in limited areas with more relaxed regulatory environments or in special circumstances (e.g., delivery of a cardiac device to meet an urgent health crisis.)

Consumer demand for cargo delivered to their preferred location and their preferred schedule is increasing, causing the number of cargo delivery events to grow. Consumers require rapid cargo delivery, and this need has compressed the elapsed time from when the cargo is created to when the cargo is delivered to them. This increasing volume and shortened time to do the delivery create capacity constraints, causing rapid cost escalation, and are sources of growing consumer dissatisfaction. To meet the expanding demand for more rapid and cost-efficient cargo delivery, UAV manufacturing companies are creating vehicles capable of handling the weight of cargo and payload containers as necessary to deliver cargo to consumers by UAVs. Current cargo-carrying UAVs require human intervention to load cargo into or attach cargo to the UAV. Current cargo-carrying UAVs also often require human intervention to unload cargo from the respective UAVs or detach the cargo from tethers or other attachments to the UAV.

### SUMMARY

Given the disadvantages inherent in existing and known devices to load and unload cargo from the cargo carrying UAVs or connect and disconnect cargo from connectors on UAVs, the present invention provides a new cargo carrying apparatus suitable for attachment to UAVs that can load cargo without human intervention into the payload container, the payload container providing a safe and secure transport container and the payload container unloading the cargo without human intervention after transport to its destination. In some embodiments, the invention may include batteries to provide power to the connected UAV.

Implementations of the present invention may be comprised of two basic elements: the payload container P1 shown in FIG. 22, that is affixed to and interconnected with a qualified UAV D1, and the payload pad R1 that is used to hold the cargo to be loaded into the payload container. The payload pad may further provide one or more navigation aids to the in-flight UAV to guide the UAV into a landing position suitable for loading or unloading and holding the cargo to be loaded into the payload container or holding the cargo that has been unloaded from the payload container. The payload container and payload pad are designed to work together to provide the functionality described herein and are described separately in the following.

### Payload Container

The payload container is comprised of a chamber P1 shown in FIG. 1 to hold the cargo during transit and which is positioned during loading and unloading operations by the UAV legs D2 shown in FIG. 22 at a height to interact with the payload pad R1 to load and unload cargo without human intervention. The payload container further comprises cargo doors C10, C11 shown in FIG. 2 to allow cargo to be moved into and out of the chamber, the cargo doors being opened and closed by the mechanism comprising C2, C3, C4, C6, C7, C8, C9 shown in FIG. 2. The payload container may further comprise one or more electronic sensors and controls C5 to assure safe operations and protective panels P7 that protect the apparatus, improve the payload container's aesthetic presentation and improve the payload container's flight characteristics. In some embodiments, the payload container may contain batteries connected to the UAV to provide power to the UAV, B2 shown in FIG. 7. In these embodiments, the payload container attached to a UAV may be interchanged between loaded and unloaded states and enable recharging of these batteries when attached or detached from the UAV and loading and unloading the payload container separately from attachment to the UAV.

The payload container chamber P1, may be constructed from carbon fiber panels, and in alternative embodiments, it can be constructed from other materials with similar weight and strength characteristics. The payload container chamber has four sides and a top which are constructed of fixed panels. The payload container sides and top may be circular, domed, or have other geometric shapes in other configurations. The payload container has elements P4 to enable mechanical connection to the UAV. As the mechanical and safety-related requirements for attachment to a UAV are specific to each UAV, the attachment shown in the illustrations and described herein are generalized in nature. These mechanical attachments will take different forms and be attached to different sections of the UAV airframe. Some of these attachment concepts may provide a permanent or semi-permanent attachment, while others may provide a quick-release capability enabling payload containers to be quickly detached or attached to a UAV. Such attachment or detachment mechanisms may include mechanical, electrical, signal, and data communications connections.

The bottom of the payload container chamber is comprised of two cargo doors C10, C11 shown in FIG. 2, each of which is coupled to the payload container by a plurality (shown here by non-limiting example, as four) links C2, C3, symmetrically affixed with two links on each of the two shorter ends of the doors, whose attachment to the doors and the payload container are connectors that permit free and unrestricted rotation. Each of the shorter door edges comprises one element in four-bar linkage on each end of the doors designed to provide opening and closing paths of the doors, these opening and closing paths enabling the interaction with the payload pad to load and unload cargo without human intervention. The mechanical forces for the opening and closing movement of each cargo door and for holding the door open or closed are provided by four separate links C4, one on each end of the two doors, which are moved by their attachment to one of the two suitable linear actuators, such as lead-screw assemblies, one lead screw assembly positioned on each end of the payload container, each of which is driven by an electric motor. The electric motors are suitable position control motors, such as stepper motors or other motors equipped with encoders and current sensors that enable the onboard electronics to know the precise position of the doors and the forces required to move the doors at the various stages of opening or closing and thereby detecting the presence or absence of cargo weight and providing an estimate of the cargo weight. In alternate embodiments, these control functions can be accomplished by proximity switches, load cells, strain gauges, limit switches, and other components that sense the location, motion, forces, and other attributes, states, and conditions.

The interior or upper surfaces of the payload container cargo doors have a sheet of material that is durable, flexible, and has a low coefficient of friction on the surface of the door, S7 shown in FIG. 4. In some embodiments, this can be constructed of a combination of para-aramid synthetic fiber such as Kevlar® and high molecular weight urethane or similar materials. This sheet is attached to the cargo door on the long exterior edge of the door and, in the door's opened position, hangs in a vertical drop from that connection to the full width of the door. In alternate embodiments, the payload container doors may be equipped with a movable belt W1 shown in FIG. 16, that covers the interior surface of the container door. The sheet of material or the moveable belt ensures the cargo edges, as they are contacted by the payload container cargo door, create only low lateral forces on the doors such that these forces would not inhibit the payload container cargo doors' ability to close underneath the cargo.

In at least one embodiment of the invention, the payload container has a cargo stabilization apparatus. The cargo stabilization apparatus comprises low-pressure air bladders Z3 shown in FIG. 20, arranged on the inner sides of the payload container. These air bladders are coupled to air handling equipment that can provide low-pressure compressed air or a slight vacuum. When there is no cargo or when carrying cargo that does not require stabilization, or when cargo is being loaded or unloaded, the payload container will apply a slight vacuum to hold the deflated bladders against the inner sides of the payload container. When there is a requirement for load stabilization, the payload container will apply low-pressure air, inflating the bladders Z4 shown in FIG. 21, to engage the cargo and limit the cargo L3 movement.

The payload container is equipped with smoke and heat sensors Z2 shown in FIG. 20 and communication devices for communicating the state of the payload container to the UAV. The payload container may also be equipped with first and second fans Z5, Z6 and/or a camera system Z1 that may comprise one or several cameras and lights, which provides images for remote viewing and analysis of the payload container and its cargo if any, and remote viewing and analysis of loading and unloading operations.

### Payload Pad

In some embodiments, the payload pad, shown in FIGS. 8-10 is a passive device that is durable and is suitable to be deployed to multiple locations and used in a wide range of environmental conditions. The locations to which a payload pad may be deployed include but are not limited to community mailboxes, residential mailboxes, commercial building roofs, vertical living communities' residential patios, distribution centers, retail establishments, and temporary locations (for example, a parking lot in a natural disaster area).

Not all payload pad deployments will require or have the same functionality; for example, a payload pad in a temporary deployment in a parking lot during a natural disaster may not have the full complement of sensors as described in the following. In the simplest embodiment, the payload pad is a one-way device enabling cargo delivery but not supporting cargo pickup. In this embodiment, the payload pad could be a roll of canvas with the fiducials and other navigation aids printed or attached to the canvas such that it could be rapidly deployed with minimum infrastructure requirements.

In a typical embodiment, the payload pad is comprised of a base R3. The base is of sufficient dimension to permit the UAV to land on that surface and at an elevation relative to the unloading surface, such that the opening and closing of the payload container cargo doors is permitted. The cargo supporting members R1 are attached to the base, which support the weight of the cargo before loading of the cargo onto the payload container or after unloading and which may release and/or transfer the weight of the cargo to the payload container during the loading process. Additionally, the payload pad provides navigation and precision landing aids to guide the UAV to a precise location and orientation during the UAV landing operation. The cargo supporting members can take a wide variety of forms. These forms can include, for illustration purposes, that of a bristle brush R1, where the unconstrained ends support the cargo before loading steps or after unloading steps are completed. These bristles may be naturally biased to a vertically extended mode and may be comprised of a material that has the properties of providing support for the weight of the cargo, carrying the weight of the cargo resting on the ends of bristle where the weight of the cargo is distributed in a plane perpendicular to the long axis of the bristle until the bristle is deformed S1 shown in FIG. 4, by the movement of the payload container cargo doors. The payload container cargo doors' movement creates forces lateral to the long axis of the bristle at a point below the unconstrained ends of the bristle, causing the bristle to flex S1. This flexing of the bristle releases/transfers the support for the cargo, lowering the cargo onto the payload container's cargo doors which comprise the payload container's load platform. In another embodiment, shown in FIG. 16, the supporting members can be mechanical linkages that are held in a vertical orientation due to mechanical shape, magnetic forces, electromagnetic forces, or other devices that can perform the function of releasing the cargo onto the payload container's cargo doors with the application of the same mechanical forces as in the bristle instance or due to electrical devices such as reversal of electromagnetic fields or changes to the mechanical supports. In another instance, the supporting members can be rollers that are arranged such that their long axis is substantially parallel to the bottom of the cargo and substantially perpendicular to the horizontal movement of the payload container's cargo doors' movement during the loading and unloading operations where the rollers are released as the payload container's cargo doors are moved to a position to accept the weight of the cargo and where this release can be caused by the mechanical movement of the cargo doors, by electrical device, by electromagnetic device, by mechanical linkages to other components or other devices that may be caused by or triggered by the cargo door movement and position. In another embodiment, the payload pad's cargo supporting members can combine rigid elements F3 shown in FIG. 23, and foam blocks F1, F2.

Embodiments of the payload pad may include devices to enable the UAV's final landing movement to be highly accurate and correctly orientated. These devices can take a variety of forms but usually are passive devices, taking no direct action in the UAV flight, and therefore are simple, low-cost devices that are not flight safety-critical elements. One instance of this form is a visible pattern (also referred to as a fiducial) painted, dyed, affixed to, or otherwise made part of the payload pad R2 shown in FIGS. 8-10, which can be used by a pattern recognition camera on the UAV or on the payload container to provide the location and orientation references to enable the UAV to make a highly accurate and correctly oriented landing. Another embodiment may use light-emitting devices that may include laser or other types of electromagnetic radiation sources.

In some embodiments, the payload pad may be equipped to detect cargo parameters outside an acceptable tolerance. This capability may include sensing cargo that overhangs or extends into space beyond the load support area on the payload pad in such a way that it will interfere with the landing, loading, or other operations of the UAV, sensors for sensing when the load support surface is deformed by a load due to overweight cargo or unacceptable cargo geometry (for example an inverted pyramid), and sensing and reporting the state (e.g. cargo present or not present), and other parameters.

In some embodiments, the payload pad may have the ability to communicate with the UAV, the UAV control system, or other intermediate systems to enable or disable navigation and precision landing aids, report status conditions, and other data. In some embodiments where the payload pad requires electrical power, the payload pad may have the ability to operate dependently or independently of conventional connected power sources where power can be from environmental sources (e.g., solar, wind, wave, tidal, or other) augmented by battery storage devices or from periodically recharged or replaced battery storage, local power generation or other non-connected sources.

Implementations of an unmanned cargo loading and transport system adapted for operation with an unmanned aerial vehicle (UAV) may comprise a payload pad presenting a generally horizontal upper plane for supporting cargo when the pad is positioned on a generally horizontal substrate supporting the pad, the payload pad further comprising a plurality of support members together defining at upper ends thereof an upper plane of the payload pad, each of the support members having a vertically extended mode for supporting weight imposed downward on the support member and a retracted mode in which the support member is of shorter vertical length than the support members in the vertically extended mode, the support members being movable from the extended mode to the retracted mode when exposed to a lateral force applied to the support member. The system may further comprise a payload container comprising an upper portion adapted to attach to a UAV, a plurality of side portions coupled to the upper portion and extending downward from the upper portion, and a lower portion that together with the upper portion and side portions defines an enclosure for holding cargo in the payload container. The payload container may be further adapted to pick up the cargo from the payload pad by transferring the weight of the cargo from the payload pad to the payload container and hold the cargo within the payload container while in transit by a UAV wherein a lower portion of the payload container may comprise two generally opposed cargo doors movably mounted at opposed sides of the side portions of the payload container and movable inwardly to a closed position such that opposed edges of the cargo doors are substantially adjacent to present a generally closed bottom of the payload container, the cargo doores further movable outwardly to an open position at which the opposed edges of the cargo doors are distal from one another to present an open bottom of the payload container for receiving cargo when the payload container is positioned at the payload pad. The system may further comprise a motive power mechanism coupled to the cargo doors for selectively moving the doors between their open and their closed positions.

Particular aspects may comprise one or more of the following features. One or more of the support members may comprise bristles that are naturally biased to the vertically extended mode. The payload pad may further comprise a landing aid adapted to be sensed by one or more sensors on the UAV for guiding the UAV to a desired location and orientation on the payload pad. One or more of the support members may comprise a series of rollers carried on generally vertically extending links mounted on the payload pad for pivotal movement about horizontally extending axes that are substantially parallel to the opposed edges of the cargo doors. The landing aid may comprise a transmitter for transmitting signals to the one or more sensors on the UAV.

Implementations of an unmanned cargo loading and transport system adapted for operation with an unmanned aerial vehicle (UAV) may comprising a payload pad presenting a substantially horizontal upper plane for supporting cargo when the payload pad is positioned on a substantially horizontal substrate supporting the payload pad, the payload pad comprising a bed of deformable elastomeric material. The system may further comprise a payload container comprising an upper portion adapted to be attached to a UAV, a plurality of side portions coupled to the upper portion and extending downward from the upper portion, and a lower portion that together with the upper and side portions defines an enclosure for holding cargo in the payload container. The payload container may be adapted to pick up the cargo from the payload pad by transferring a weight of the cargo from the payload pad to the payload container and holding the cargo within the payload container while in transit by a UAV wherein a lower portion of the payload container may comprise two generally opposed cargo doors movably mounted at opposed sides of the side portions of the payload container and movable inwardly to a closed position such that opposed edges of the cargo doors are substantially adjacent to present a generally closed bottom of the payload container. The cargo doors may be further movable outwardly to an open position at which the opposed edges of the cargo doors are distal from one another to present an open bottom of the payload container for receiving cargo when the payload container is positioned at the payload pad. They system may further comprise a motive power mechanism coupled to the cargo doors for selectively moving the doors between their open and their closed positions.

Particular aspects may comprise one or more of the following features. The deformable elastomeric material may comprise an elastomeric foam material. The payload pad may comprise two beds of deformable elastomeric material positioned in an end-to-end configuration and separated by a substantially vertically-extending partition member. The substantially vertially-extending partition member may be substantially a same vertical height as a vertical height of the two beds of deformable elastomeric material. The payload pad may further comprise a landing aid adapted to be sensed by one of more sensors on the UAV for guiding the UAV to a desired location and orientation on the payload pad. The landing aid may comprise a transmitter for transmitting signals to the one or more sensors on the UAV.

Implementations of a payload container adapted for use in an unmanned aerial vehicle (UAV) cargo transport system, with the payload container being adapted to selectively engage, hold and release cargo to be transported by the UAV may comprise an upper portion having a connector for attaching the payload container to a UAV, a plurality of side portions extending downward from the upper portion, and a lower portion that together with the upper and side portions defines an enclosure for holding cargo in the payload container, the lower portion comprising two generally opposed cargo doors movably mounted at opposed sides of the side portions of the payload container and movable inwardly to a closed position such that opposed edges of the cargo doors are substantially adjacent to present a generally closed bottom of the payload container that substantially closes the lower portion of the payload container. The cargo doors may be further movable outwardly to an open position at which the opposed edges of the cargo doors are distal from one another to present an open bottom of the payload container for at least a substantial portion of the lower portion of the payload containter for receiving cargo when the payload container is positioned above cargo to be transported. The system may further comprise a motive power mechanism coupled to the cargo doors for selectively moving the doors between their open and their closed positions for opening and closing the lower portion of the payload container.

Particular aspects may comprise one or more of the following features. The payload container may further comprise a linkage for coupling the cargo doors to the payload container for pivotal and translational movement between the open positon and the closed position. The motive power mechanism may be configured to move the payload container cargo doors between the open position and the closed position via the linkage. An upper surface of the payload container cargo doors may be comprised of a material having a coefficient of friction less than about 0.2. The side portions of the payload container are formed of planar members may be comprised of at least one of a metal and a plastic. The linkage may comprise a four-bar linkage mechanism. The cargo doors may comprise a sheet of a material having a coefficient of friction that is less than or equal to about 0.2 on the upper surface of the cargo doors. The payload container may further comprise a battery for storing electrical power on board the payload container. The payload container may further comprise a camera system for imaging cargo held in the payload container. The payload container may further comprise a temperature sensor, transfer ports in the payload container for transferring air into and out of the payload container and a fan operatively associated with the temperature sensor, the transfer ports and fan configured to move air from outside the payload container through the payload container to regulate an interior temperature of the payload container. The payload container may further comprise an air bladder system for holding cargo in place in the payload container during transport.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly sets forth the “special” definition of that term and explains how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or Claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventor not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DETAILED DESCRIPTION, DRAWINGS, and CLAIMS.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 provides a perspective view of a payload container detached from an unmanned aerial vehicle.

FIG. 2 provides an isometric view of a side of the payload container with the protective panel removed. This view presents an embodiment of the cargo door attachment and movement mechanisms, including the electric motor, worm drive, and propulsion linkages.

FIG. 3 provides an isometric view of the side of the payload container with the protective panel removed. This view presents an embodiment of the payload container cargo doors shown in an opened position and an embodiment of the payload pad shown in relation to the payload container.

FIG. 4 provides an isometric view of a side of the payload container with the protective panel removed. This view presents an embodiment of the payload container cargo doors shown in the process of lifting the cargo from the payload pad. This view further presents the interaction of the payload container cargo doors with the payload pad.

FIG. 5 provides an isometric view of a side of the payload container with the protective panel removed. This view presents exemplary detail of an embodiment of the payload container cargo door where the cargo door is covered with a material having a low coefficient of friction and the cargo door is further equipped with a low-friction sheet that enables the cargo to move along the door's surface as the cargo door moves under the cargo.

FIG. 6 provides a detailed isometric view of an example of an interaction of the cargo and the payload container cargo doors, as presented in FIG. 5.

FIG. 7 provides an isometric view of an alternative embodiment of the payload container where the payload container comprises batteries.

FIG. 8 provides a perspective view of the payload pad. The view presented is an embodiment that includes cargo carrying bristles and UAV precision landing aids.

FIG. 9 provides an isometric top view of an embodiment of the payload pad.

FIG. 10 provides an isometric side view of an embodiment of the payload pad.

FIG. 11 provides an isometric view of a side of the payload container with the protective panel removed. This view presents a set of linkages used to modify the movement path of the cargo doors when opening and closing.

FIG. 12 provides an isometric view of a side of the payload container with the protective panel removed. This view presents another exemplary embodiment of the cargo door opening and closing mechanism.

FIG. 13 provides an isometric view of a side of the payload container with the protective panel removed. This view presents another embodiment of the cargo door opening and closing mechanism presented in FIG. 12 and illustrates the initial movement of the cargo door opening and closing processes.

FIG. 14 provides an isometric view of a side of the payload container with the protective panel removed. This view presents another embodiment of the cargo door opening and closing mechanism presented in FIG. 12 and illustrates the lateral movement phase of the cargo door opening and closing processes.

FIG. 15 provides an isometric view of a side of the payload container with the protective panel removed. This view presents another embodiment of the cargo door opening and closing mechanism presented in FIG. 12 and illustrates a scooping movement phase of the cargo door opening and closing processes.

FIG. 16 provides a perspective view of the payload container where only the cargo doors are shown, cargo is in position for loading by the payload container, and an alternative embodiment of the payload pad employs a roller assembly to support the cargo.

FIG. 17 provides an isometric view of the items presented in FIG. 16, with the payload container cargo doors shown in the initial phase of loading the cargo.

FIG. 18 provides an isometric view of the items presented in FIG. 16, with the payload container cargo doors shown in an interim phase of loading the cargo.

FIG. 19 provides an isometric view of the items presented in FIG. 16, with the payload container cargo doors shown in their position after cargo loading is completed.

FIG. 20 provides a perspective view of an interior of an embodiment of the payload container, which provides an image of a camera, smoke detector, and deflated cargo stabilization bladders.

FIG. 21 provides a perspective view of an interior of an embodiment of the payload container, which provides an image of inflated cargo stabilization bladders stabilizing cargo for flight.

FIG. 22 provides a perspective view of a typical UAV with a payload container attached that is shown positioned over a payload pad in the location and orientation used for the pickup or delivery of cargo.

FIG. 23 provides an isometric view of the payload container with the protective panel removed, positioned over an embodiment of the payload pad that utilizes a rigid element and foam pads to hold the cargo for loading or after unloading operations.

FIG. 24 provides an isometric view of the items presented in FIG. 23, with the payload container cargo doors shown during the closing motions and illustrates the deformation of the foam pads caused by the payload container cargo doors.

FIG. 25 provides an isometric of the items present in FIG. 23, where the payload container cargo doors have lifted the cargo from the foam pads and illustrates the clearance of the payload container cargo doors and the rigid element.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

### Overview

Implementations of the present invention as disclosed herein depart significantly from the conventional concepts and designs of the prior art. This invention provides a device to load cargo into an unmanned aerial vehicle (UAV) for transport without human intervention and has the ability to unload cargo from UAVs at the intended delivery location without human intervention. The loading and unloading of cargo is accomplished with limited complexity, with the implementation of the invention at the pickup and delivery locations. This enables the rapid deployment of UAV pickup and delivery to a multiplicity of consumer delivery and pickup locations.

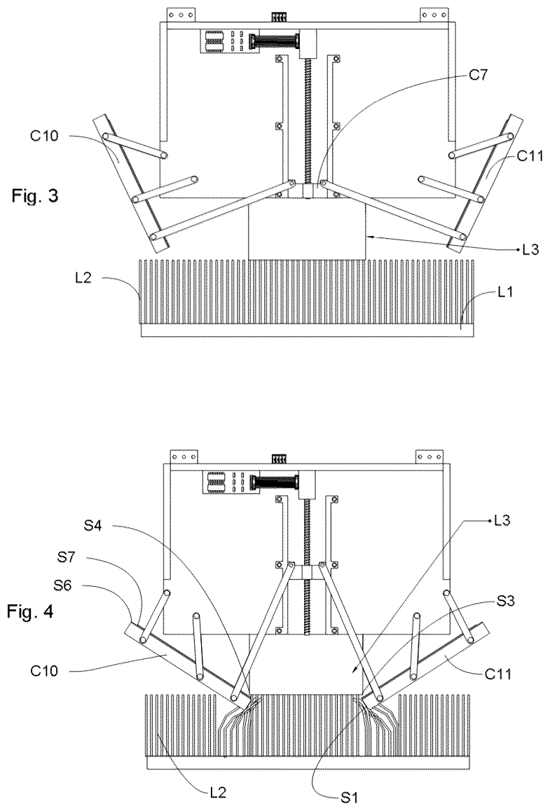

Implementations of the invention are comprised of two major elements: 1) a payload pad L1, (See FIGS. 3 and 8-10), that is a low cost, passive element that can be rapidly deployed to a plurality of UAV delivery points and elements of which will additionally be deployed at the UAV loading points including vehicles and package disbursement centers such as retailers, fulfillment centers and package carriers' hubs among others; and 2) a payload container P1 that is permanently, semi-permanently, or detachably secured to a UAV and is used to load cargo from a payload pad L1 without human intervention and securely transport the cargo to a delivery location where it can unload without human intervention.

### Payload Container Enclosure

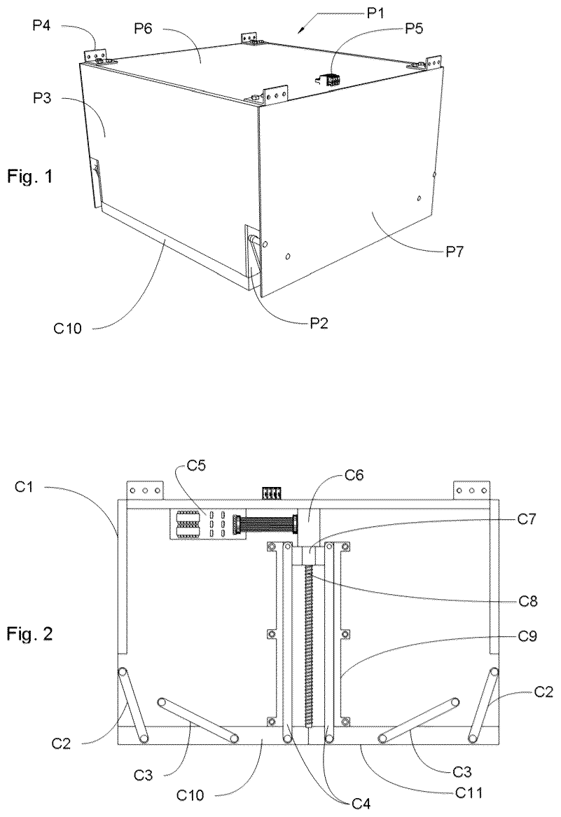

As shown in FIG. 1, the payload container P1 is a secure container used to carry cargo from an originating point to an intended destination on a UAV. In at least one embodiment, the payload container P1 is constructed of five fixed panels, P2, P3, P6 shown in FIG. 1. The five panels comprise a top panel P6 and four side panels P2, P3 of the payload container P1. The bottom of the payload container is formed from two movable panels C10, C11, shown in FIG. 2, which form the payload container cargo door for cargo loading and unloading and are described separately in more detail. Additionally, there are carbon fiber panels P7 on each side of the payload container P1 that provide cover and protection for the mechanisms that operate the payload container doors C10, C11 and improve the aerodynamics of the payload container P1 during flight. In alternate implementations, the payload container enclosure panels can be constructed of other lightweight materials with the requisite mechanical properties for strength and durability, such as by non-limiting example, a metal or a plastic. In other embodiments, the geometry of the payload container can be changed to meet specific requirements, for example, a hexagonal-shaped enclosure, or any other appropriate shape that is conducive to transporting differently shaped cargo.

### Payload Container Attachment

The payload container P1 may comprise the mechanical attachment components P4 to attach the payload container to the UAV. These components P4 and the location of their attachment to the payload container P1 are adapted to the specific needs of the UAV to which they are affixed and to the specific configuration of the payload container P1. The payload container attachments P4 also include the electrical connectors P5 that provide the power transfer and the electronic communication between the payload container and the UAV.

### Payload Container Doors

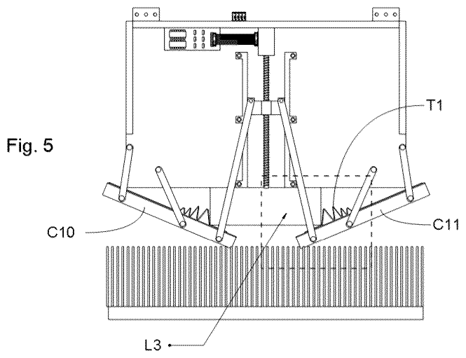

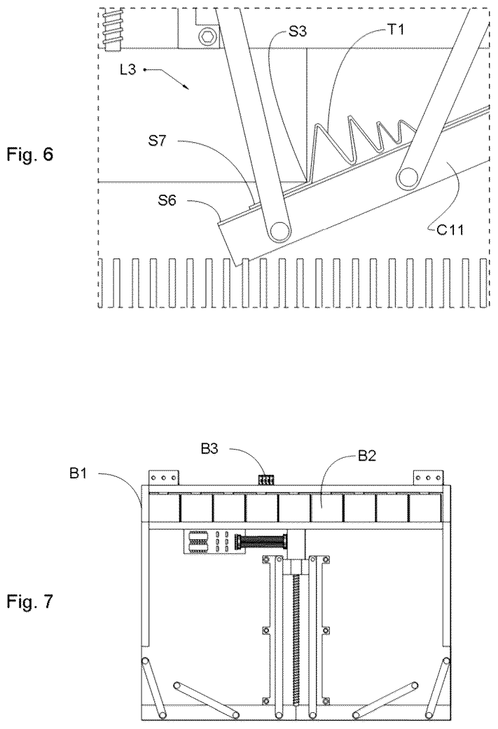

In at least one embodiment of the invention, the payload container cargo doors C10, C11 comprise two carbon fiber panels that, when closed, form the bottom panel in the payload container C10, C11, shown in FIG. 3. During the loading and unloading sequences of the payload container operation, cargo is required to move laterally relative to the cargo edges S3, S4 when in contact with these upper cargo door surfaces S6 as shown in FIG. 4. Therefore, in at least one embodiment of this invention, the payload container doors comprise one or more materials having a coefficient of friction that is less than or equal to about 0.2 so as to reduce the fricative force of the upper surfaces S7 of the cargo doors C10, C11 when in contact with the cargo. In at least one embodiment of the payload container doors C10, C11, a thin sheet of ultra-high molecular weight polyethylene (UHMWPE) material S6 may be affixed to the surface S7 of these doors. To further assure that the cargo is able to move relative to the payload container doors during the loading and unloading processes, in at least one embodiment, the payload container doors comprise a thin sheet of low friction para-aramid synthetic fiber such as Kevlar® or other similar materials that is attached to the exterior edge of the door on the interior surface S7 shown in FIG. 4. This low friction sheet is of flexible material and in some embodiments, is only attached at the outer edge of the doors and drapes down over the doors C10, C11 when the doors C10, C11 are fully opened. As the doors close, the edges of the cargo S3, S4 loaded during the cargo loading process are placed in contact with the interior surface of the low friction sheet S7. As the payload container doors C10, C11 continue to close, the edge (or corner) S3, S4 of the cargo resting on the low friction sheet S7 slides on the sheet S7 causing the sheet to gather into one or more folds or ridges T1 shown in FIGS. 5-6, toward the exterior edges of the payload container door C10, C11 thereby lifting the cargo from the payload pad L1 shown in FIG. 6. This motion continues until the payload container doors C10, C11 are fully closed against the payload container enclosure and the cargo is fully contained inside the payload container P1.

In some embodiments, the UHMWPE and para-aramid synthetic fiber or equivalent may be replaced with a small belt conveyor segment W1 on the payload container doors as shown in FIG. 16. This belt conveyor segment W1 may approximate the full, unimpeded width and length of the payload container doors C10, C11 and may be powered or unpowered. A powered conveyor belt segment could include a separate electrical motor or a ratcheting device that generates its movement from the closure of the payload container cargo doors.

### Payload Container Door Connector Links

In at least one embodiment of the invention, each payload container cargo door is affixed to the payload container by two connector links attached to both short edges of each payload container cargo door for four connector links per door C2, C3 in FIG. 5. The attachment of each connector link to the payload container cargo door permits each connector link to rotate around the point at which they are pivotally connected. The other ends of these connector links are affixed to the payload container panels on the ends of the payload container, and these attachments will also allow the rotation of each link around the point to which they are pivotally connected.

In at least one embodiment of the invention, there are two motive force links attached to both exterior edges of the short edge of each of the two payload container cargo doors C4 shown in FIG. 5. The motive force links' attachment points on these doors are near the long edge of the payload container cargo door at the center of the payload container when the payload container cargo doors are closed. In at least one embodiment of the invention, the other end of the motive force links is attached to a slider block C7 shown in FIG. 3, that is driven by a lead screw C8 shown in FIG. 2, that moves the slider block in a motion perpendicular to the payload container cargo doors when they are in a closed position. In other embodiments of this invention, this motive force can be applied by other suitable linear actuators such as a pneumatic or hydraulic cylinder. In other embodiments, this motive force can be applied by multiple lead screws or pneumatic or hydraulic cylinders. In other embodiments of this invention, the motive force can be supplied by linkages attached to rotating elements driven by electrical, pneumatic, or hydraulic mechanisms. These links provide the force to move the cargo doors into an open position or move them into a closed position.

The connector links, the payload container cargo door, and the payload container panel form the four elements of a four-bar linkage which is moved by the motive force links to create a motion path for the doors that are designed to intersect with the bristles or other support elements of the payload pad at a point below their contact with the cargo shown in FIG. 4, causing the bristles or other support elements to deflect or otherwise release the cargo onto the cargo doors as they move in a scooping motion through the bristles or other support elements underneath the cargo and then move with a vertical motion component to lift the cargo into the payload container.

In alternate implementations of the invention, the attachment point of one or both connector links to the payload container panels may be modified by adding additional linkages U2 shown in FIG. 11 and suitable electrical motors, lead screws, pneumatic or hydraulic devices U1, to vary the attachment point of the linkage U3 to the payload container to modify the movement of the payload container cargo doors to improve their ability to lift/lower larger, heavier or irregular shaped cargo from/to the payload pad, into and out of the payload container.

### Payload Pad

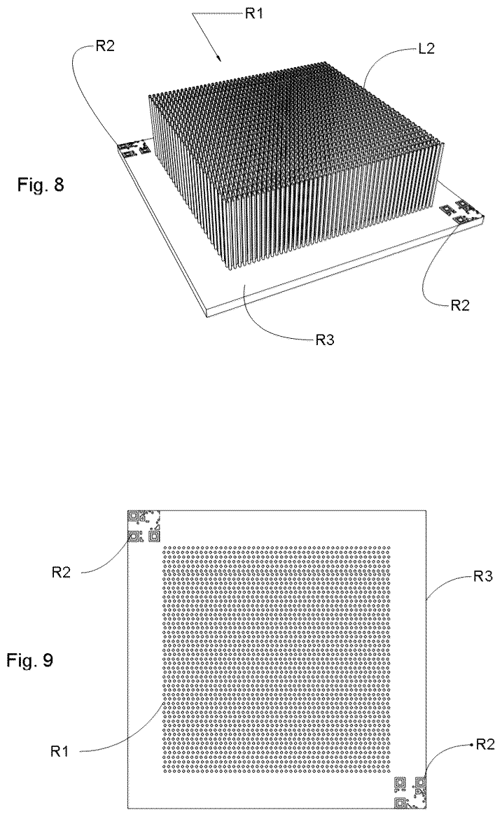

The payload pad shown in FIGS. 8-10 comprises a base R3 that provides an attachment point for the support elements L2 that support the cargo when the cargo is placed on it. This base R3 constrains these elements appropriately to permit them to support the cargo in the ready-for-pickup state and then release the cargo onto the payload container cargo doors C10, C11 when the payload container cargo doors are closing and thereby intersect the support elements as occurs during the cargo pickup operation.

In at least one embodiment of the invention, the support elements of the payload pad L1 are bristles R1 of an appropriate length and cross-section and formed from a material that has the appropriate mechanical properties that enable them to support cargo that meets the cargo weight and shape criteria for the payload pad L1, when the payload pad L1 is in its ready-for-pickup state. During the cargo pickup process, the payload container cargo doors C10, C11 intersect these bristles R1 and cause the bristles R1 to deflect, which reduces the ability of the bristles R1 to support the cargo, thereby lowering the cargo until it contacts the payload container cargo doors C10, C11.

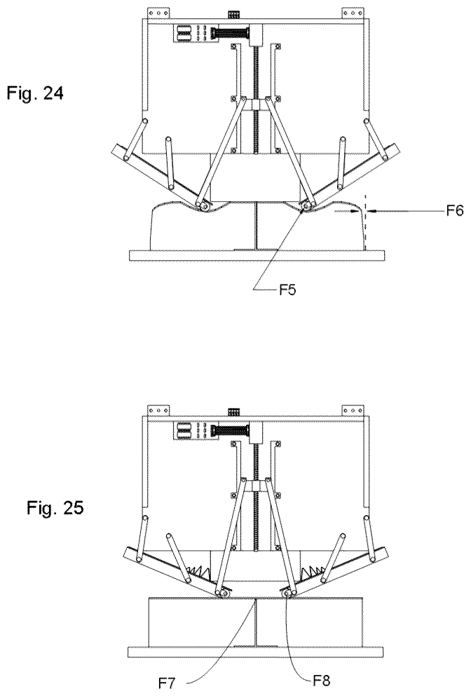

In an alternate embodiment shown in FIGS. 23-25, the function of the support elements may be comprised of suitable elastomeric foam material. In this embodiment, the payload pad L1 comprises a base R3 supporting an inverted T-shaped rigid element F3 to which are adhesively attached foam elements F1 and F2, the foam elements suitable to support any rotational force that may be created by the cargo L3 asymmetrical force on the rigid element F3. A flexible fabric F4 may be adhesively attached to the foam blocks F1 and F2 and is coupled to the rigid element F3. In this embodiment, the payload container doors C10, C11 comprise a roller F5 or rounded element of low friction material such having a coefficient of friction less than or equal to about 0.2 such as by non-limiting example, UHMWPE. The flexible fabric F4 comprises a high-strength fabric such as para-aramid synthetic fiber such as Kevlar® with embedded fiberglass strands or similar material arranged to limit any deformation of length. The attachment of the fabric F4 to the rigid element F3 causes the deformation of the foam block by the closing of the payload container door F5 to pull the fabric from the edge of the foam block F6, keeping the cargo stable on the foam blocks. The payload container doors and their mechanical linkages are such that the opening and closing movement does not create any contact between the payload container doors and the rigid element F3 by keeping the height of the roller F8 above the height of the rigid element F7 during the door closing movement.

In alternate embodiments, the support elements can comprise a mechanical linkage with a hinge point near the base that also has a hinge point nearer the midpoint of the linkage, the hinge points being limited in motion and in opposite directions. The hinge points in the fully erect orientation can be biased in that orientation by magnetic force or mechanical design features such as a spring that can be overcome or released by the payload container cargo doors during the cargo pickup operation.

In alternate embodiments, the support elements can be comprised of tines hinged near the connection to the payload pad base. These tines can be held in their upright state by mechanical properties of their design (for example, detents on the edges of the tines held in place by a spring) or magnetic or other devices.

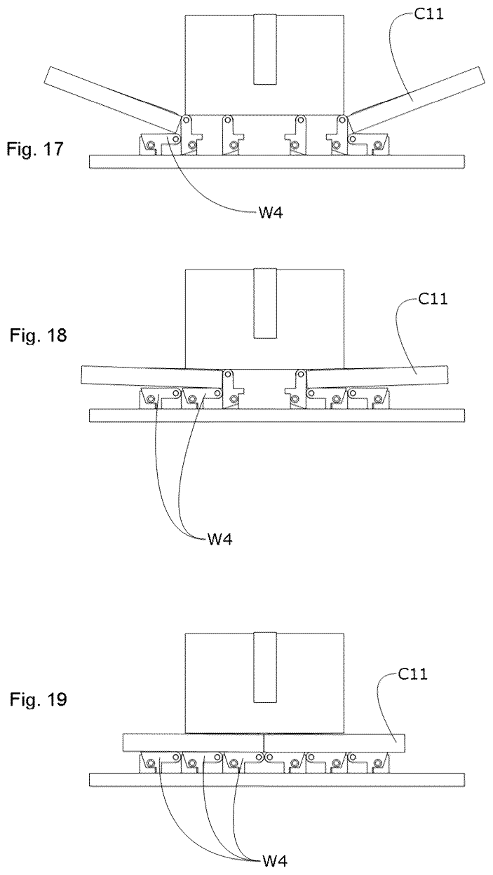

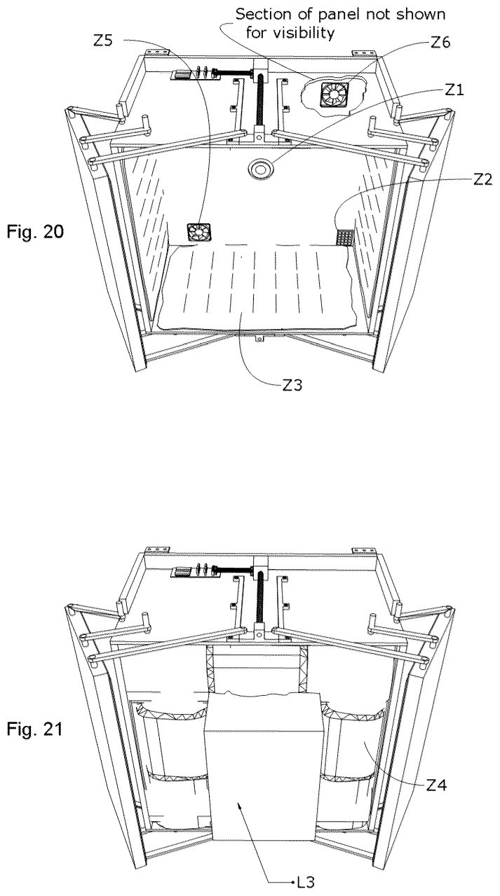

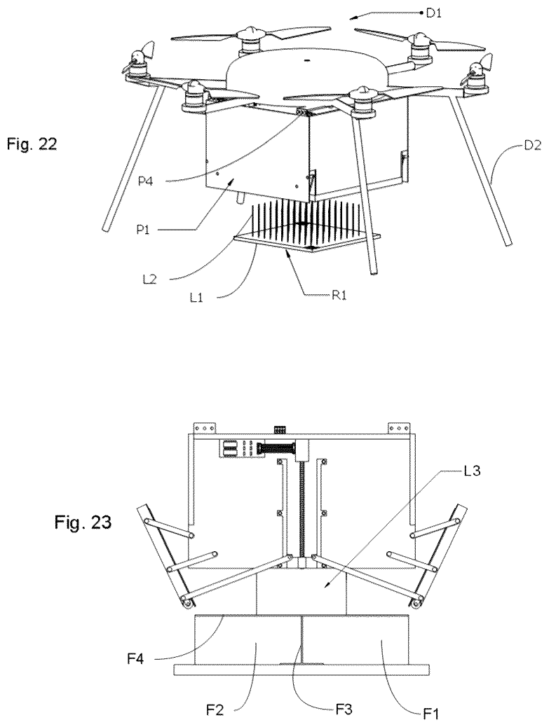

In alternate embodiments shown in FIGS. 16-19, the support elements can be comprised of rollers W2 that are arranged such that their long axis is substantially parallel to the bottom of the cargo L3 and substantially perpendicular to the horizontal vector of the payload container's cargo door C11 movement during the loading and unloading operations where the rollers are released as the payload container's cargo doors C10, C11 are moved to a position to accept the weight of the cargo and where this release can be caused by the mechanical movement of the payload container doors, by electrical devices, by electromagnetic devices, by mechanical linkages to other components or other devices that may be caused by or triggered by the cargo doors movement and position.

The payload pad L1 also provides one or more guidance elements that enable the UAV to make the precision landing at the payload pad L1, enabling the loading and unloading of the cargo into and out of the payload container as described herein. These guidance elements may be visible marks (e.g. optical fiducials) as shown in FIGS. 8-10 placed in consistent locations on the payload pad.

### Cargo Loading Operation

The cargo loading operation of a UAV equipped with a payload container P1 may take one of two forms depending upon which of the one or more embodiments of the invention is utilized. The first form may involve a load of cargo being loaded into a payload container at a depot that has UAV loading/unloading apparatus that incorporates a payload pad. A suitably equipped depot may be a logistic center, a retail location, a mobile cargo-carrying device, or another structure. The second form may be the loading of cargo at a location with only a payload pad where cargo is manually placed upon or retrieved from the payload pad.

When loading a UAV equipped with a payload container at a suitably equipped depot, the depot may utilize an apparatus which incorporates the payload pad. The UAV at the depot is positioned in the cargo loading position. The UAV may instruct the payload container to fully open the payload container cargo doors. After the payload container has opened the cargo doors, the payload container may inform the UAV, which will inform the depot of readiness for loading the cargo. The depot may then retrieve the cargo and place it on a payload pad attached to an apparatus designed to move the cargo L3 shown in FIG. 3 to the correct position for loading. When the cargo is in the load position, the depot may then inform the UAV. The UAV then instructs the payload container to close the payload container cargo doors. During the movement of the payload container cargo doors C10 and C11 toward the closed position, the interior edges of the payload container cargo doors intersect with the bristles of the payload pad L2 that are supporting the cargo. As the payload container cargo doors close, their lateral pressure on the bristles causes the bristles to flex S1 at the point of contact with the cargo as shown in FIG. 4, reducing their capacity to support the cargo. When enough of the bristles are in the flexed state, the combined supporting force of the bristles on the cargo is reduced to less than the weight of the cargo, which thus allows the cargo to slump down onto the payload container cargo doors C10, C11. Alternatively, for packages of a sufficiently light enough weight, the doors continue to close and eventually lift the package off the unflexed bristles. The cargo edges then rest on the anti-friction sheet, which rests on the UHMWPE portion of the payload container cargo doors. Further movement of the cargo doors raises the cargo off the bristles and causes the payload container door to move laterally relative to the edges of the cargo resting on the anti-friction sheet T1, toward the center of the payload container cargo door opening S3, T1 shown in FIG. 6. The anti-friction sheet limits the lateral forces on the payload container cargo doors. When the payload container cargo doors have been fully raised and closed, the cargo is entirely and securely positioned inside the payload container.

Loading cargo into the payload container at a remote location requires the remote location's resources to place suitable cargo in the correct location and orientation on the payload pad L1 shown in FIG. 3. The person or machine that places the cargo L3 shown in FIG. 3 on the payload pad informs the UAV control system that the cargo is ready for loading and transport. The UAV equipped with a payload container is dispatched to that location. Once the UAV arrives at the remote location, it instructs the payload container to open the payload container cargo doors. The UAV may utilize the landing guidance equipment such as the fiducials on the payload pad to guide its precision landing. The UAV may then verify the payload container cargo doors are fully opened before completing the landing procedure.

After the landing has been completed, the UAV may instruct the payload container to execute the loading procedure by closing the payload container cargo doors C10, C11 shown in FIG. 5. During the movement of the payload container cargo doors toward the closed position, the interior edges of the payload container cargo doors intersect with the bristles L2 shown in FIG. 4 of the payload pad that are supporting the cargo. As the payload container cargo doors close, the lateral pressure on the bristles causes the bristles to flex S1 at the point of contact with the cargo which reduces the capacity of the bristles to support the cargo. When enough of the bristles are in the flexed state, the combined force of the bristles on the cargo is reduced to less than the weight of the cargo, which causes the cargo to slump down onto the payload container cargo doors. The cargo edges S3, S4 may rest on the anti-friction sheet, which rests on the UHMWPE portion of the payload container cargo doors. Alternatively, for packages of a sufficiently light weight, the doors continue to close and eventually lift the package off the unflexed bristles. Further movement of the doors raises the cargo off the bristles and causes the payload container cargo doors to move laterally relative to the edges of the cargo resting on the anti-friction sheet T1, toward the center of the payload container cargo doors opening. The anti-friction sheet limits the lateral forces on the payload container cargo doors. When the payload container cargo doors have been fully raised and closed, the cargo will be entirely and securely inside the payload container.

### Cargo Unloading Operation

The cargo unloading operation of a UAV equipped with a payload container has two general modes. One mode of unloading operation herein referred to as remote unloading, entails the unloading of the cargo in a manner that prevents the payload container from closing the cargo doors and requires the UAV to return to flight with the cargo doors open. The remote unloading operation will require the UAV to determine that the UAV is in the correct location and orientation prior to initiating the payload container unloading apparatus. Another mode of unloading herein referred to as depot unloading, entails the unloading of cargo in a manner that does not prevent the payload container from closing the payload container cargo doors after the unloading operation is complete, permitting the UAV to return to flight or otherwise move from the unloading position with the cargo doors closed. The depot unloading operation may require the depot apparatus to determine that the payload container and the depot apparatus are in the correct location and state prior to initiating the payload container unloading apparatus.

The remote unloading operation requires a planar surface onto which the cargo can be unloaded referred to herein as “the unloading surface.”

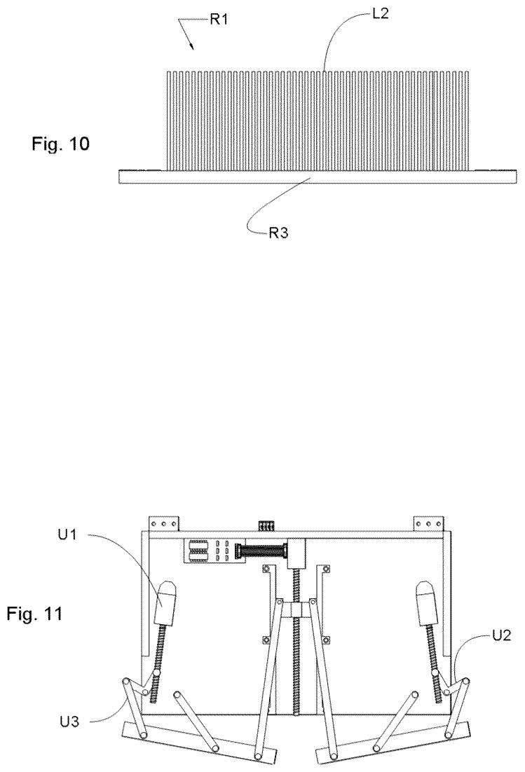

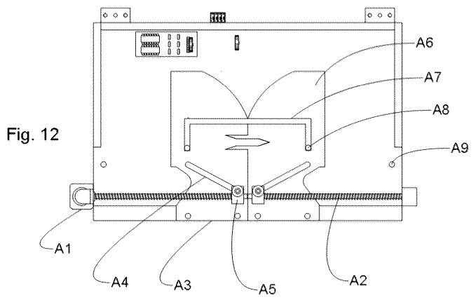

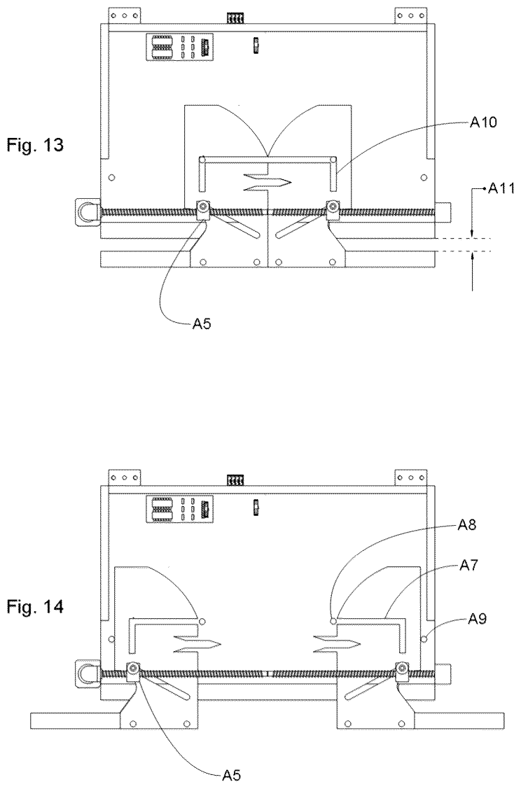

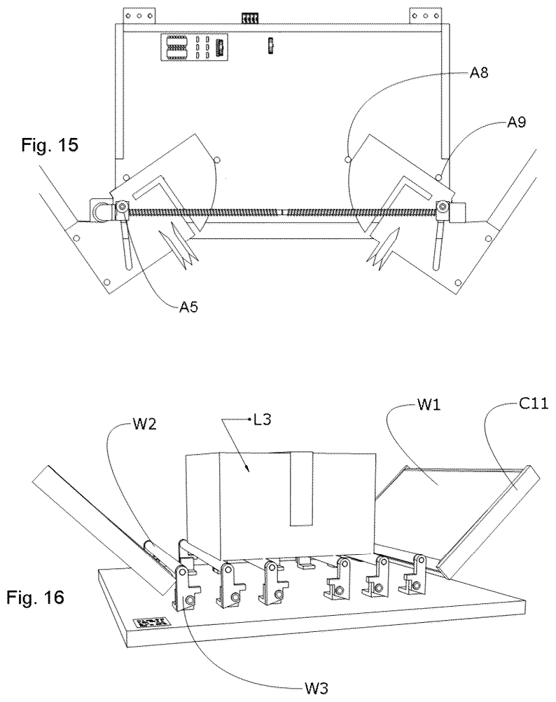

One embodiment of the unloading surface is the planar surface created by the top ends of the bristles R1 of the payload pad shown in FIG. 10. The unloading surface may be at least partially surrounded by a coplanar surface, referred to herein as “the landing surface,” of sufficient dimension to permit the UAV to land on that surface at an elevation relative to the unloading surface that is sufficient to permit the opening and closing of the payload container cargo doors. In a typical configuration, the combined elevation of the unloading surface and the height of the cargo after it has been unloaded onto that surface is such that the payload container cargo doors are unable to close after the cargo has been unloaded. The remote unloading operation provides the navigation aids, for example, the fiducials R2 shown in FIG. 9., that guide the UAV to land in the correct location and orientation. Prior to engaging the payload container's unloading apparatus, the UAV control system may validate that it is in the correct location, orientation and state.

The unloading process comprises the movement of the lead screw C8 which in turn causes the lead screw follower C7 contained between the lead screw follower guides C9 to move downwardly, moving the upper end of the linkage C4, which causes the payload container doors C10, C11 to move downwardly and outwardly as determined by the linkages C2, C3. The motion of the lead screw follower is continued until the cargo doors C10, C11 are fully opened, as shown in FIG. 3. where the upward and inward corners S3, S4 of the cargo are vertical to the inside surface of the payload container's walls P3 as shown in FIG. 1. assuring the cargo is completely released from the payload container. The payload container cargo doors may report to the UAV that it has completed the unloading process.

The depot unloading operation may be performed at a suitably equipped depot where a suitably equipped depot could be a logistic center, a retail location, a mobile cargo-carrying device, or another structure. The depot unloading operation requires design features or mechanical or human resources at the unloading location to receive and move the unloaded cargo downwardly or to move the UAV with the attached payload container upwardly to a distance such that the unloaded cargo does not impede the closing motion of the payload container cargo doors.

This physical separation of the top of the unloaded cargo and the lowest position of the payload container cargo doors during an opening or closing cycle, can alternatively be created by a cargo unloading position that is above a cavity of sufficient length, width and depth such that after the cargo is unloaded into the cavity, the tallest point of the unloaded cargo will be below the arc of the payload container cargo doors during the open/close cycle.

For the depot unloading operation the depot may provide the navigation aids to guide the landing of the UAV and may provide additional apparatus to move the UAV and position it over the depot's unloading apparatus. The depot control may inform the UAV when the UAV is correctly positioned and the depot is in a state that is ready to receive the cargo. The UAV control system instructs the payload container to unload the payload container. The payload container engages the payload containers unloading apparatus.

The payload container may deactivate any cargo stabilization devices that may have been activated. The payload container may then engage the cargo door operating mechanism by energizing the lead screw motor C6 shown in FIG. 2. Movement of the lead screw C8 in turn causes the lead screw follower C7 contained between the lead screw follower guides C9 to move downwardly, thereby moving the upper end of the linkage C4, which causes the payload container doors C10, C11 to move downwardly and outwardly as determined by the linkages C2, C3.

The cargo L3 may then slide down the low friction sheet S7 until it rests on the cargo supporting members L2.

The motion of the lead screw follower is continued until the cargo doors C10, C11 are fully opened as shown in FIG. 3. where their upward and inward corners are vertical to the inside surface of the payload container's walls P3 shown in FIG. 1. assuring the cargo is completely released from the payload container.

In places where the description above refers to particular implementations of systems and methods for cargo delivery by unmanned aerial vehicles it should be readily apparent that a number of modifications may be made without departing from the spirit thereof and that these implementations may be applied to other to systems and methods for cargo delivery by unmanned aerial vehicles.

We claim:

1. An unmanned cargo loading and transport system adapted for operation with an unmanned aerial vehicle (UAV) the system comprising:
a payload pad presenting a generally horizontal upper plane for supporting cargo when the payload pad is positioned on a generally horizontal substrate supporting the payload pad, the payload pad further comprising a first elastomeric foam element and a second elastomeric foam element having a t-shaped support member therebetween, the first elastomeric foam element and the second elastomeric foam element having a same height as the t-shaped support member, the upper surface of the first and second elastomeric foam elements and the t-shaped support member defining an upper plane of the payload pad, the first and second elastomeric foam members having a vertically extended mode for supporting weight imposed downward on the first and second elastomeric foam members and a retracted mode in which at least a portion of the first and second elastomeric foam members is of shorter vertical length than the vertical length of the first and second elastomeric foam members in the fully vertically extended mode, the first and second elastomeric foam members being movable from the fully vertically extended mode to the retracted mode when exposed to a lateral force applied to the first and second elastomeric foam members;
a payload container comprising:
an upper portion adapted to attach to the UAV;
a plurality of side portions coupled to the upper portion and extending downward from the upper portion; and
a lower portion that together with the upper portion and side portions defines an enclosure for holding cargo in the payload container, the payload container further adapted to pick up the cargo from the payload pad by transferring the weight of the cargo from the payload pad to the payload container and hold the cargo within the payload container while in transit by the UAV, and wherein a lower portion of the payload container comprises two generally opposed cargo doors movably mounted at opposed sides of the side portions of the payload container and movable inwardly to a closed position such that opposed edges of the cargo doors are substantially adjacent to present a generally closed bottom of the payload container, the cargo doors further movable outwardly to an open position at which the opposed edges of the cargo doors are distal from one another to present an open bottom of the payload container for receiving cargo when the payload container is positioned at the payload pad; and
a motive power mechanism coupled to the cargo doors for selectively moving the doors between their open and their closed positions.

2. The system of claim 1, wherein the payload pad further comprises a landing aid adapted to be sensed by one or more sensors on the UAV for guiding the UAV to a desired location and orientation on the payload pad.

3. The system of claim 2, wherein the landing aid comprises a transmitter for transmitting signals to the one or more sensors on the UAV.

4. An unmanned cargo loading and transport system adapted for operation with an unmanned aerial vehicle (UAV), the system comprising:
a payload pad presenting a substantially horizontal upper plane for supporting cargo when the payload pad is positioned on a substantially horizontal substrate supporting the payload pad, the payload pad comprising a bed of deformable elastomeric material having at least one t-shaped support member therein;
a payload container comprising:
an upper portion adapted to be attached to a UAV;
a plurality of side portions coupled to the upper portion and extending downward from the upper portion; and
a lower portion that together with the upper and side portions defines an enclosure for holding cargo in the payload container, the payload container adapted to pick up the cargo from the payload pad by transferring a weight of the cargo from the payload pad to the payload container and holding the cargo within the payload container while in transit by a UAV, and wherein a lower portion of the payload container comprises two generally opposed cargo doors movably mounted at opposed sides of the side portions of the payload container and movable inwardly to a closed position such that opposed edges of the cargo doors are substantially adjacent to present a generally closed bottom of the payload container, the cargo doors further movable outwardly to an open position at which the opposed edges of the cargo doors are distal from one another to present an open bottom of the payload container for receiving cargo when the payload container is positioned at the payload pad; and
a motive power mechanism coupled to the cargo doors for selectively moving the doors between their open and their closed positions.

5. The system of claim 4, wherein the deformable elastomeric material comprises an elastomeric foam material.

6. The system of claim 5, wherein the payload pad comprises two beds of deformable elastomeric material positioned in an end-to-end configuration and separated by a substantially vertically-extending partition member.

7. The system of claim 6, wherein the substantially vertially-extending partition member is substantially a same vertical height as a vertical height of the two beds of deformable elastomeric material.

8. The system of claim 4, wherein the payload pad further comprises a landing aid adapted to be sensed by one of more sensors on the UAV for guiding the UAV to a desired location and orientation on the payload pad.

9. The system of claim 8, wherein the landing aid comprises a transmitter for transmitting signals to the one or more sensors on the UAV.
